(19) United States
(12) Patent Application Publication
(10) Pub. No.: US 2006/0054153 A1
(43) Pub. Date: Mar. 16, 2006

(54) Electric concrete cutting chain saw

(76) Inventors: James L. Vanderzanden, Sherwood, OR (US); Kent M. Johnston, Lake Oswego, OR (US); Ian S. Osborne, Hillsboro, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 10/940,294

(22) Filed: Sep. 13, 2004

(51) Int. Cl. B28D 1/08

(52) U.S. Cl. 125/21

(57) ABSTRACT

A concrete cutting chain saw has heretofore been considered a rugged performing tool demanding high horsepower and unavailable to the homeowner having only single phase electrical power for powering such a tool. This has been addressed and resolved by the reduction of chain speed to thereby increase torque for the lower horsepower capability. Chain width and thereby cutting width is also reduced, and cutting implements per cutter are reduced, all lowering power demands and resulting in a smooth concrete cutting chain saw for homeowner use. Also included is a conversion kit for converting available homeowner power tools, e.g. an angle grinder for use as a concrete cutting chain saw.

### FIELD OF THE INVENTION

This invention relates to the provision of a concrete cutting chain saw that can be powered by conventional single phase household electric power.

### BACKGROUND OF THE INVENTION

Historically, concrete cutting saws have been diamond impregnated circular blade cutting saws. Such saws require large circular blades, e.g. a 16″ in diameter blade that has a maximum cutting depth of e.g. 6″. Further, a configuration of a cut made by the circular saw blade is curved with a shallow lead in cut and a shallow exit cut. Thus, a through cut of e.g. 10″ will require a shallow lead in and shallow exit cut that extends beyond the 10″ through cut, at both ends, by several inches.

These and other factors have prompted the development of a chain saw type concrete cutting saw. The configuration of the cut can be made square and thus provide a clean cutout of a square or rectangular shape as may be desired, e.g., for providing a window or door opening in a concrete wall.

A chain saw type concrete saw has several concerns. The chain is comprised of alternating center drive links and pairs of opposing side links. Certain or all of the paired side links cooperatively carry a cutting head including a matrix block impregnated with diamond chips. This arrangement requires a thicker cut to accommodate the triple width thickness of center and side links as compared to the single thickness of a circular blade. In any event, concrete cutting chain saws have been considered to require a substantial drive motor, e.g. ranging from a low of about 5 horsepower motor to as high as 9 horsepower motor. Motors having such substantial horsepower are primarily hydraulic and gas motors, with some at the low end of the power requirements driven by an industrial electric motor, i.e., that requires the use of a separate generator and cannot be simply plugged into a household electric outlet.

### BRIEF DESCRIPTION OF THE INVENTION

Horsepower is equated to torque and speed. For cutting concrete the prevailing view is that the speed must be maintained at an established high level. At the desired level of surface speed, the power source must generate a minimum level of torque, i.e., as necessary to drive the chain at the desired speed while cutting through the concrete. Heretofore the speed and torque considered necessary has eliminated the use of household electrical power as a power source for concrete cutting saws.

It is an objective of the present invention to provide an electric concrete cutting chain saw that can be operated on a single phase household electric power source. This is necessarily achieved by reducing the required horsepower to accommodate the electrical power output of single phase electricity. Whereas it was found that the torque cannot be reduced significantly to achieve that end, the invention challenges the prevailing view as to the chain speed requirement. The surface speed was reduced via the reduction in size of the drive sprocket. It was found that some reduction in chain speed was acceptable and surprisingly enabled the retention of sufficient torque to satisfy lesser concrete cutting demands, all at a horsepower requirement achievable with single phase electric power.

Other modifications that further assist in enhancing torque are the narrowing of the chain and bar width to allow a more narrow kerf to be cut and a reduction in the number of diamond chips (cutting implements) in the cutting blocks of the saw chain cutters. The latter reduces the number of diamonds that participate in the cutting action at any given time which reduces power and torque demand.

Whereas the cutting tool does not cut with the speed and power of industrial size concrete cutting saws, what does occur is the matching of the cutting capabilities of the saw to the power capabilities of a single phase electrical power source. Such provides the homeowner with an affordable, smooth running and efficient electric powered concrete cutting tool that has not been heretofore considered achievable as a homeowner type tool.

As a further innovation, the lower powered concrete cutting chain saw is alternatively provided by the conversion of existing single phase power tools e.g. an angle grinder. An angle grinder has a drive shaft that drives a grinding disk. The disk is removed and replaced with a drive sprocket. In a particular version of the grinder, a feature that enables multi-positioning of a front handle for the grinder provides a mount for a saw chain housing and guide bar (on which a saw chain is mounted). The size of the sprocket dictates the linear speed of the chain and is selected to satisfy the criteria for concrete cutting.

The invention will be more fully understood and appreciated with reference to the following detailed description and accompanying drawings.

### BRIEF DESCRIPTION OF THE DRAWINGS

FIGS. 1 and 2 are top and side views respectively of a concrete cutting chainsaw in accordance with the present invention and includes an electric power head and conversion kit for adapting the power head for use as a concrete cutting chain saw;

FIGS. 3 and 4 are front and rear views of the chain saw as shown in FIG. 2;

FIG. 5 is a section view taken on view lines 5-5 of FIG. 2;

FIG. 6 illustrates the kit portion of the chain saw of FIG. 1 as generally viewed on view lines 6-6 of FIG. 1;

FIG. 7 is a view similar to FIG. 2 but having a front cover removed to better see the mounting arrangement; and

FIG. 8 is a chart showing different power availabilities for concrete cutting saws and is used as an aid to the explanation of the present invention.

### DESCRIPTION

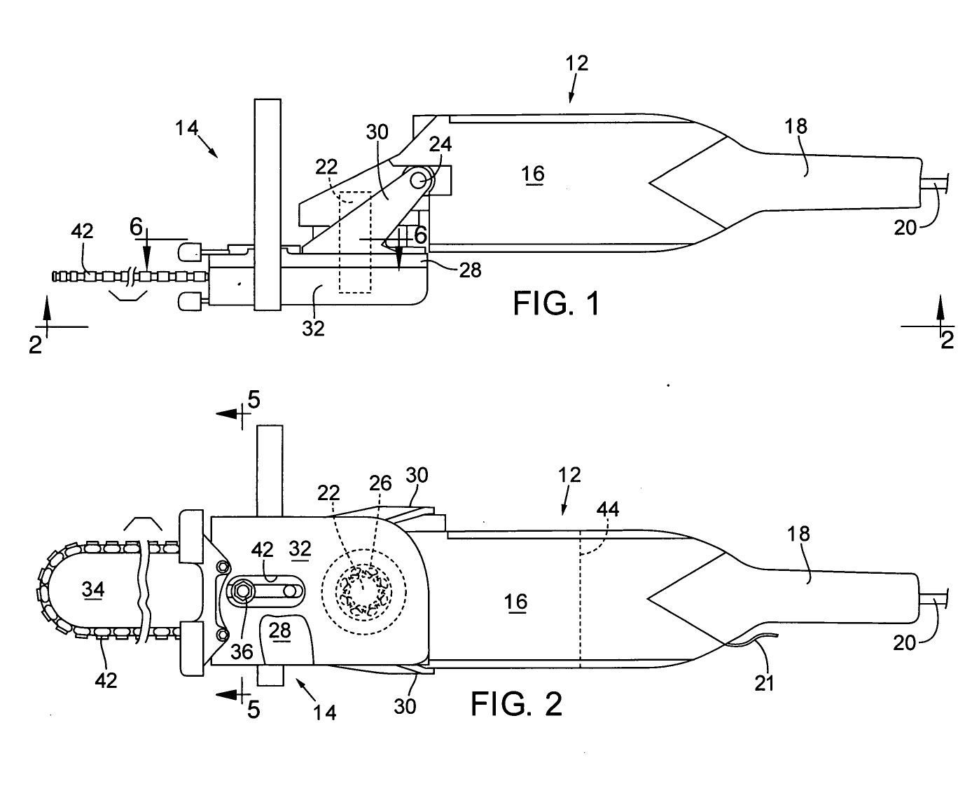

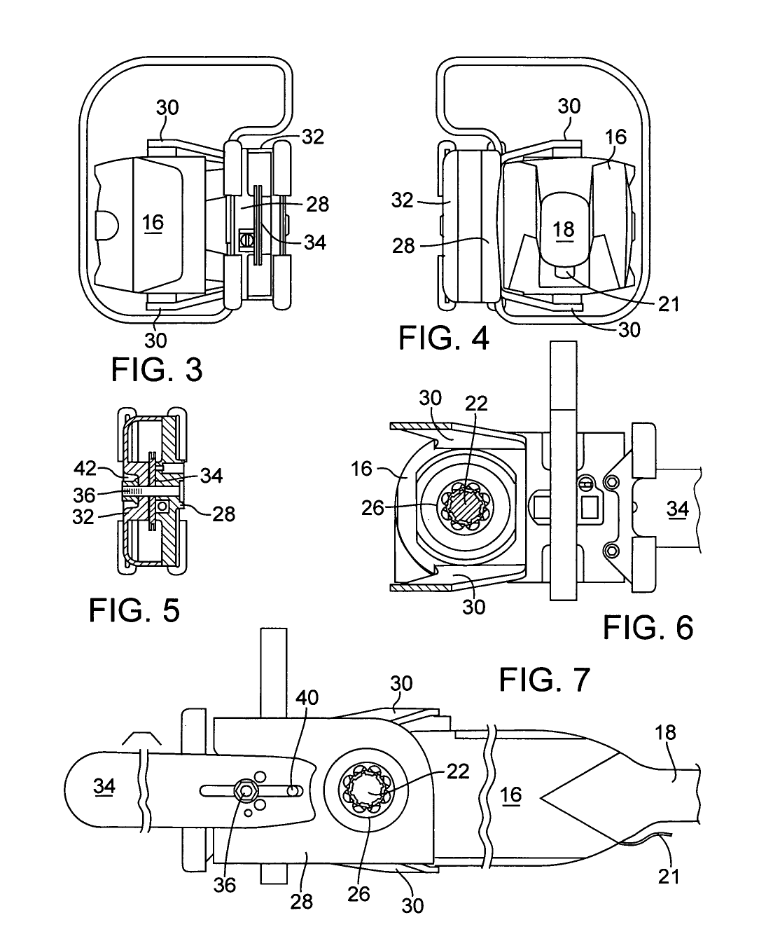

Reference is made to FIGS. 1 and 2 which illustrate an electronic concrete cutting chain saw in accordance with the present invention. The chain saw of the figures includes a power head 12 and a conversion kit 14 that converts the power head for use as a concrete cutting chain saw.

The power head 12 includes a body 16 having a handle portion 18. An electric motor inside the housing is connectable and powered by a single phase electric outlet via cord 20. The electric motor through actuation of the trigger switch 21 (see FIG. 2) rotatably drives a drive shaft schematically illustrated by dash line 22.

The power head of the illustration is provided with opposing threaded holes [24] into which fastening bolts 24 are inserted to secure the components of the conversion kit 14 to the power head 12. (In a different adaptation of the power head 12, the bolt holes [24] may be used to secure a front handle, e.g. when adapted to receive a grinding disk or wheel secured to the drive shaft 22.) The conversion kit includes (as a separate component) a drive sprocket mounted to the drive shaft 22 which can be best seen in FIG. 6. (See view lines 6-6 of FIG. 1.) A mounting bracket 28 includes flanges 30 that receive the bolts 24 for securing a mounting bracket 28 to the power head 12.

A removable cover 32 is secured to the bracket 28 and is removed as seen in FIG. 7 to expose the underlying drive shaft 22 in driving engagement with sprocket 26. Mounted to the bracket 28 and extended outboard of the sprocket 26 is a guide bar 34 which is secured by bolt 36 to the bracket 28, the bolt 36 fitted through a slot 38 in the bar for slidable extension of the bar as permitted by pin 40.) A detent 42 in the cover 32 (see FIG. 2) permits access to the bolt head. A concrete cutting saw chain 42 as seen in FIGS. 1 and 2 (illustrated and described in commonly owned U.S. Pat. No. 6,186,136) is mounted so as to be guided on the periphery of the guide bar 34 and which is also entrained on sprocket 26 aligned with the guide bar, and driven by sprocket 26 around the guide bar. Driving the sprocket 26 and thus the saw chain 42 is achieved by the rotatable drive shaft 22 actuated by trigger 21. (See also FIG. 5 which is a cross section as noted by view lines 5-5 in FIG. 2.)

The tool as described above, i.e., the combination of power head 12 and conversion kit 14 enables the replacement of the kit, e.g., with a grinder wheel for use, e.g., as an angle grinder as previously indicated. Quite readily, the mounting bracket and chain saw components can be removed by removal of bolts 24 and then replacement of sprocket 26 with a grinder disk or wheel. In this event a front handle (forward of rear handle 18) would be secured into one of the threaded holes 24. Although not shown, the rear handle 18 in some versions of power heads that are convertible to a chain saw as described, can be rotated in either rotative direction, e.g. 90° around a break line indicated at 44 in dash line. This is beneficial for orienting the tool to the task, e.g., for grinding or cutting vertically as opposed to horizontally.

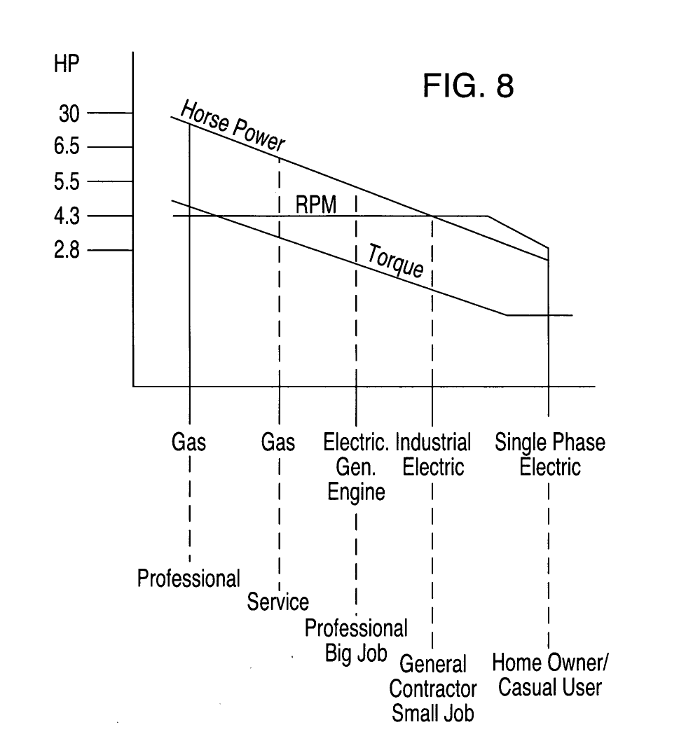

The invention is further explained with reference to the chart of FIG. 8. The available horsepower available from a power source is critical to the performance of a task such as cutting through, e.g., an 8″ thick block of concrete. The greater the horsepower the more rugged and longer lived the cutting tool. Thus, for major day after day cutting, the user needs a high horsepower power source which, in today's market, likely requires a high horse power gas engine. Such a user is here referred to as a professional user and he may require as high as a 30 horsepower motor. In today's market, a concrete cutting saw of this capability may cost in the order of $8,000. A semi professional user may be happy with a 6 to 7 horsepower motor at a cost of about $3,500. A general contractor, with less frequent need for such a tool, typically has a generator in his cadre of equipment having a capability of e.g. 5 to 6 horsepower, the tool having a cost of about $1,500, and a small job contractor with occasional use and having industrial electrical power capability may be satisfied with a horsepower requirement of about 4.5 horsepower and a tool cost of about $900.

As previously explained and as illustrated by the chart of FIG. 8, which plats the different horsepower size tools as among the mentioned users, the revolutions per minute (rpms) have been considered a necessary constant and remains level across the spectrum of the four mentioned user types On the other hand, the torque follows a downward path consistent with the downward path of the horsepower availability. Thus, when it became apparent that there was inadequate torque to perform the cutting operation, it was assumed that single phase electrical current, e.g., household current, was inadequate to provide the horsepower demands for a concrete cutting tool, e.g., a concrete cutting chain saw.

The inventors departed from the conventional wisdom and conceived the idea that horsepower could be reduced without satisfying torque if the rpms were reduced. The smaller saw and the type and frequency of concrete cutting by e.g. a homeowner renders speed of cutting less important. As illustrated in the chart, the horsepower was reduced, not by reducing torque but by reducing chain speed. It was determined that the reduction in rpms should create a surface/linear speed of the chain of no greater than about 4,800 feet/minute. The unexpected result was the favorable matching of speed and torque to the less abusive jobs of the homeowner. The homeowner can power the saw with single phase household current and achieve a smooth yet adequate cutting performance at a cost that is a fraction of that required for the higher powered industrial/professional cutting tools.

The invention at least in part is believed to be the matching of a concrete cutting chain saw design to the power capabilities of household current. In the course of this development, there has been a further realization that because tool abuse is lowered, the cutting links themselves can be made smaller and thereby reduce the kerf width which in turn reduces torque demand. Still further, again because speed is not a primary objective of a homeowner, the number of exposed diamond chips (cutting implements) per cutting block can be reduced which again reduces torque demand.

The interrelationship of these changes has produced a unique concrete cutting chain saw that provides a desirable match up to the needs of a typical homeowner having concrete cutting tasks. Those skilled in the art will conceive of further alterations and variations without departing from the invention. Accordingly, the above disclosed embodiment is included as an example of but one embodiment, albeit a preferred embodiment, of the invention. The invention is not to be limited to that of the disclosure but is intended to be encompassed by the definition of the claims appended hereto, the terms of which are to be given a broad interpretation as used in the art.

1. A concrete cutting chain saw comprising:
a low horsepower power head including a rotatable drive shaft, said power head connectable to a single phase power source for electrically driving the drive shaft;
a drive sprocket mounted for rotation by the drive shaft;
a guide bar secured to the power head and a concrete cutting chain mounted on the guide bar and drive sprocket to be driven by the drive sprocket around the guide bar;
said sprocket and power head cooperatively designed to provide surface speed for said cutting chain of no greater than about 4,800 feet per minute to thereby accommodate a horsepower availability from the single phase electrical circuit while maintaining sufficient torque to drive the chain at said speed for cutting concrete.

2. A concrete cutting chain saw comprising:
a power head including a rotatable drive shaft, said power head connectable to a single phase power source for electrically driving the drive shaft;
a drive sprocket mounted for rotation by the drive shaft;
a guide bar secured to the power head and a concrete cutting chain mounted on the guide bar and drive sprocket to be driven by the drive sprocket around the guide bar;
said sprocket and power head cooperatively designed to provide surface speed for said cutting chain of no greater than about 4,800 feet per minute to thereby accommodate a horsepower availability from the single phase electrical circuit while maintaining sufficient torque to drive the chain at said speed for cutting concrete
said chainsaw is derived of the power head and conversion kit, said power head adapted to provide driving power for multiple tool needs and said conversion kit comprises;
components compatible with said power head and including said drive sprocket, guide bar and cutting chain and further including a housing or mountably receiving said guide bar; and
further including a housing mount for mounting the housing to the power head and as mounted to the power head, positioning the guide bar relative to said drive sprocket for cooperatively receiving the saw chain to be driven by said drive shaft around said guide bar.

3. A concrete cutting chain saw as defined in claim 2 wherein said power head is provided with threaded bores, and said housing including a bracket with through bores cooperatively designed to mount said housing to the threaded bores of said power head.

4. A concrete cutting chain saw as defined in claim 1 wherein said power head is configured to operate on a maximum power input of 2500 watts.

5. A concrete cutting chain saw as defined in claim 1 wherein the maximum width of any one cutting segment on the cutting chain is less than 0-225 inches to-allow use of the low horsepower power head.

6. A concrete cutting chain saw comprising:
a power head including a rotatable drive shaft, said power head connectable to a single phase power source for electrically driving the drive shaft;
a drive sprocket mounted for rotation by the drive shaft;
a guide bar secured to the power head;
a concrete cutting chain mounted on the guide bar and drive sprocket to be driven by the drive sprocket around the guide bar;
wherein said sprocket and power head cooperatively configured to provide a desired sure speed for said cutting chain and accommodate a maximum power input of 2500 watts, while maintaining sufficient torque to drive the chain at the desired surface speed sufficient to cut concrete.

7. A concrete cutting chain saw comprising:
a low horsepower power head including a rotatable drive shaft, said power head connectable to a single phase power source for electrically driving the drive shaft;
a drive sprocket mounted for rotation by the drive shaft;
a guide bar secured to the power head; and
a concrete cutting chain mounted on the guide bar and drive sprocket to be driven by the drive sprocket around the guide bar, the cutting chain having a maximum width of less than 0.225 inches to allow the power head to operate using a-horsepower availability from the single phase electrical circuit while maintaining sufficient torque to drive the chain at a speed sufficient for cutting concrete.
